(19) United States
(12) Patent Application Publication
(10) Pub. No.: US 2026/0176169 A1
(43) Pub. Date: Jun. 25, 2026

(54) Swimming Pool Treatment

(71) Applicant: Sensor Electronic Technology, Inc., Columbia, SC (US)

(72) Inventors: Piyush Sharma, Columbia, SC (US); Carlton James Gibson, Columbia, SC (US)

(21) Appl. No.: 19/419,358

(22) Filed: Dec. 15, 2025

Related U.S. Application Data
(60) Provisional application No. 63/736,963, filed on Dec. 20, 2024.

(51) Int. Cl. C02F 1/32; C02F 1/00; C02F 103/42; E04H 4/12

(52) U.S. Cl. CPC C02F 1/325; C02F 1/001; E04H 4/1209; C02F 2103/42; C02F 2201/326; C02F 2303/04

(57) ABSTRACT

A treatment system for a pool can include at least one far-UV light source for emitting far-UV light into water within the pool and/or onto a surface within the pool that is in contact or may contact the water. The treatment system can include a treatment controller configured to manage treatment of the water and/or the surface by controlling operation of the at least one far-UV light source.

### REFERENCE TO RELATED APPLICATIONS

The current application claims the benefit of U.S. Provisional Application 63/736,963, filed on 20 Dec. 2024, which is hereby incorporated by reference.

### TECHNICAL FIELD

The disclosure relates generally to the treatment of pool water and/or one or more surfaces of a pool, and more particularly, to a solution for treating pool water and/or one or more surfaces of a pool using far ultraviolet light.

### BACKGROUND ART

Currently, swimming pool disinfection is primarily characterized by two approaches: chemical treatments and traditional ultraviolet-C (UV-C) light systems.

Chemical disinfection, particularly through the use of chlorine, is the most common approach. Chlorine is effective in killing bacteria and other microorganisms. However, the use of chlorine has several drawbacks. Prolonged exposure to chlorine can cause skin and eye irritation for swimmers. Chlorine also can damage hair with prolonged exposure. The use of chlorine requires careful management to avoid the formation of harmful byproducts such as chloramines. These byproducts can lead to unpleasant odors and additional maintenance challenges. Furthermore, chlorine-based treatments necessitate regular handling, storage, and monitoring, which adds to operational costs and complexity for proper disinfection.

Traditional UV-C disinfection systems use UV-C light to effectively inactivate microorganisms by disrupting their DNA, thereby preventing them from reproducing. Traditional UV-C disinfection systems allow users to significantly reduce the amount of chlorine needed to maintain a healthy pool environment. However, the UV-C light sources are generally installed in closed systems external to the pool due to UV safety hazards. For example, UV-C light sources are typically fixed in place and rely on a pumping system to take wafer from the main pool area and channel it in close proximity to the UV-C light source. This configuration limits the integration of the UV-C light disinfection with the pool environment. As a result, the UV-C light cannot target micro-organisms like algae, mold, and bacteria at their source. Additionally, low and medium pressure mercury lamps are often used as the UV-C light sources, which presents a potential contamination hazard if any mechanical damage causes mercury to enter the pool water.

### SUMMARY OF THE INVENTION

Aspects of the invention provide a treatment system for a pool which can include at least one far-ultraviolet (far-UV) light source for emitting far-UV light into water within the pool and/or onto a surface within the pool that is in contact or may contact the water. The treatment system also can include a treatment controller configured to manage treatment of the water and/or the surface by controlling operation of the at least one far-UV light source.

Embodiments of the invention can integrate far-ultraviolet (far-UV) technology into treatment mechanisms for a pool. Far-UV light operates within the 200 nanometer to 235 nm wavelengths, and has unique characteristics that distinguish it from the longer wavelength ultraviolet light. Notably, far-UV light is inherently safer for human exposure, exhibiting negligible adverse effects especially resulting from brief periods of contact. However, far-UV remains effective at deactivating microorganisms, thereby providing effective disinfection, even when swimmers may be present in the pool.

Embodiments can include far-UV light sources located in various locations within the pool, such as along the pool edges, on the pool bottom, on floating or suspended buoys, on pre-existing sub-surface structures, and/or the like. Embodiments can be configured to ensure highly uniform coverage and can be adapted based on the design and usage patterns of the pool, thereby providing a flexible and integrated approach to pool water and/or pool surface treatment.

By incorporating far-UV light treatment into the pool water located within the pool, embodiments can be less dependent on alternative treatments, such as chemical and UVC treatments, which occur outside of the pool. As a result, pool water maintenance can have lower chemical costs and lower associated risks and maintenance requirements. A reduction in chemical use also can contribute to more sustainable pool management by decreasing an environmental impact of the water treatment and reducing a frequency of water changes. Embodiments can include any number of far-UV light sources placed in any number of locations within the pool, thereby providing a highly adaptable solution for treating pool water in any of various pool shapes and sizes and in diverse settings from residential to commercial pools.

Embodiments can integrate one or more water quality sensors, which can acquire data used to monitor real-time conditions within the pool. By analyzing data from these sensor(s), embodiments of the treatment system can adjust the operation of one or more treatment components, including the far-UV light sources, to optimize disinfection, energy use, chemical use, and/or the like. Such an approach can not only improve an efficiency of treatment, but also reduce energy consumption, chemical use, and/or the like, and the corresponding operational costs, thereby addressing inefficiencies of traditional water treatment approaches.

A first aspect of the invention provides a treatment system for a pool, the treatment system comprising: at least one far-UV light source configured to emit far-UV light into water within the pool and/or onto a surface within the pool that is in contact or may contact the water; and a treatment controller configured to manage treatment of the water and/or the surface by controlling operation of the at least one far-UV light source.

A second aspect of the invention provides a pool comprising: a treatment system including: at least one far-UV light source configured to emit far-UV light into water within the pool and/or onto a surface within the pool that is in contact or may contact the water; and a treatment controller configured to manage treatment of the water and/or the surface by controlling operation of the at least one far-UV light source.

A third aspect of the invention provides a pool comprising: a circulation and filtration system; and a treatment system including: at least one far-UV light source configured to emit far-UV light into water within the pool and/or onto a surface within the pool that is in contact or may contact the water; a treatment controller configured to manage treatment of the water and/or the surface by controlling operation of the at least one far-UV light source; and at least one sensor configured to acquire data regarding the water and/or the surface, wherein the treatment controller is configured to manage operation of the at least one far-UV light source using the data.

The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative pool including a treatment system according to embodiments.

FIG. 2 shows a schematic of an illustrative treatment system according to embodiments.

FIG. 3 shows an illustrative flow chart of a treatment process that can be implemented by the treatment controller according to embodiments.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a treatment system for a pool which can include at least one far-UV light source for emitting far-UV light into water within the pool and/or onto a surface within the pool that is in contact or may contact the water. The treatment system can also include a treatment controller configured to manage treatment of the water and/or the surface by controlling operation of the at least one far-UV light source. Embodiments of the treatment system can enable in situ treatment of pool water, even while the pool water is within the pool and when swimmers may be present.

As used herein, “treatment” includes directing germicidal radiation into water and/or onto one or more surfaces. In embodiments, the surface(s) can include surfaces associated with a pool that are or may be in contact with the water (e.g., based on a height of the water in the pool, waves created in the pool water, and/or the like), such as a pool liner, water piping, a surface of a fixed passive feature, a fixture for an active feature, a circulation and filtration component, and/or the like. The treatment can result in one or more contaminants (e.g., pathogens) present in the water and/or on the surface(s) to be killed, inactivated, and/or the like. Embodiments of the treatment can include a dose sufficient to decontaminate, disinfect, sterilize, and/or the like, a treated volume of water and/or surface to a desired level. It is understood that embodiments of the treatment described herein may not result in a volume of water and/or surface being fully decontaminated, disinfected, sterilized, and/or the like.

Embodiments utilize properties of far-UV light, a specific wavelength range within ultraviolet light that is inherently safer for human exposure compared to conventional UVC radiation. As used herein, ultraviolet (UV) light includes radiation having a wavelength between 10 nanometers and 400 nanometers. Ultraviolet C (UVC) light is a subtype of ultraviolet light having wavelengths between 100 nanometers and 280 nanometers. Far-UV light is a subtype of UVC light having wavelengths between 200 nanometers and 235 nanometers. In more particular embodiments, far-UV light having wavelengths between 207 nanometers and 222 nanometers can be utilized.

Embodiments can comprise one or more far-UV light sources, one or more sensors, and a control unit, which can comprise one or more computing devices.

Each far-UV light source can emit ultraviolet light having wavelengths within the far-UV wavelength range, which is safe for humans and can effectively neutralize pathogens, thereby providing effective treatment while posing minimal risk to human health. In embodiments, one or more far-UV light emitting diodes (LEDs) are used to generate the far-UV light.

Aspects of the invention will be further described in conjunction with implementation in a typical residential inground pool. However, it is understood embodiments can be implemented in conjunction with pools of any size, shape, and/or the like, and pools that are used for any of various purposes. To this extent, embodiments can be implemented in conjunction with a hot tub, an endless pool, a therapy pool, an above ground pool, a diving pool, a wading pool, a wave pool, an Olympic size pool, etc. A pool can be a private pool primarily utilized for personal use, or a public pool primarily used, for example, by the general public, such as at a park, at a commercial establishment or private club, such as at a hotel, a university, a membership club, etc.

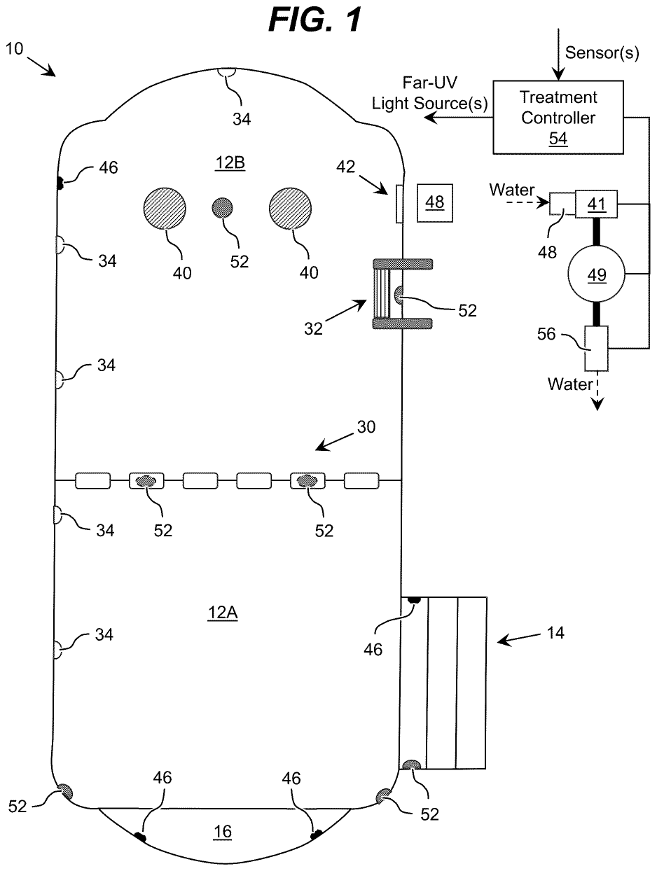

Turning to the drawings, FIG. 1 shows an illustrative pool 10 including a treatment system according to embodiments. In general, the pool 10 can include various fixed passive features that enable swimmers to readily use and enjoy the pool 10. As used herein, a fixed passive feature is an attribute of the pool 10 that does not change, cannot be readily removed or moved (e.g., without removing the water), and/or the like. For example, the pool 10 can include a shallow end 12A and a deep end 12B with a graded transition region therebetween. The shallow end 12A can be utilized by smaller children and others, while the deep end 12B can provide an area of the pool in which it is safe to jump in. The pool 10 also can include steps 14 that allow individuals to enter and exit the water on a shallow end of the pool 10. The pool 10 also can include one or more benches 16, each of which can provide a platform on which individuals can comfortably sit while in the water.

The pool 10 also can include various active features that can be utilized by swimmers. As used herein, an active feature is a feature that can be removed and/or relocated, replaced, turned on/off, and/or the like (e.g., without requiring removal of the water). For example, to allow for identification of the end of the shallow end 12A and the transition to the deep end 12B, the pool 10 can include a removable indicator 30, which can comprise a rope with a series of buoys or the like, floating on the water surface. The removable indicator 30 can be secured to opposing sides of the pool 10 at locations corresponding to the end of the shallow end 12A and a start of the graded transition region toward the deep end 12B. The pool 10 also is shown including a removable ladder 32, which can be located in the deep end 12B of the pool to allow individuals to enter and exit the pool 10 in the deep end 12B. In general, the ladder 32 can hang over a side of the pool and include steps submerged in the water. Additionally, the pool 10 can include various light fixtures 34, which can provide illumination of the water, e.g., while users are swimming at night.

For treating and removing debris and particulates from the pool 10, the pool can include a circulation and filtration system, which can include various fixtured located in or at least partially in the pool 10. For example, the pool 10 can include one or more drains 40, typically located at the bottom of the pool 10 in the deep end 12B, and a skimmer 42 located at a surface of the water. A pump 44 can be configured to pump water out of the pool 10 via the drains 40 and the skimmer 42 and return water to the pool 10 via one or more return jets 46 which can be placed at various locations about the pool 10. The circulation and filtration system can include various filters, such as large particulate filters 48, which can be located above the drains 40, at the skimmer 42 (e.g., accessible via a cover located adjacent to the skimmer 42, before the pump 41, and/or the like. Additionally, a small particulate filter 49 can be located after the pump to remove smaller particulates using any solution, such as, sand, cartridge, diatomaceous earth, and/or the like.

As discussed herein, the pool 10 can include a treatment system for treating the pool water. In embodiments, the treatment system can include an external disinfection component 56 for treating the pool water prior to its reintroduction into the pool by the circulation and filtration system. Embodiments of the disinfection component 56 can include a chemical disinfection component, which can add one or more chemicals, such as chlorine, to disinfect the pool water. Embodiments of the disinfection component 56 can include an ultraviolet-C disinfection component, which can illuminate pool water passing by with sufficient ultraviolet-C light in order to disinfect the pool water.

While the external disinfection component 56 is shown having a particular arrangement with respect to the circulation and filtration system, it is understood that embodiments of the treatment system can include one or more external disinfection components 56 located anywhere along the circulation and filtration system. It is also understood that typical embodiments of the circulation and filtration system and the treatment system can include various valves, piping, etc., to enable the flow of water through the system to be redirected to or away from certain components, enable the discharge of water from the system, enable the cleaning of one or more components, etc., which are not shown for clarity.

Embodiments of the treatment system further include one or more far-UV light sources 52, which can be configured to illuminate pool water within the pool and/or one or more surfaces of the pool with far-UV light in order to treat the pool water and/or pool surface(s). Utilization of far-UV light can enable the treatment system to provide in situ treatment of the pool water and/or surfaces of the pool, even when the pool is in use.

In embodiments, when a surface is irradiated by the far-UV light, the surface can be treated in order to prevent the surface from being damaged by the ultraviolet light and/or be treated with a material that is used in conjunction with the ultraviolet light. For example, a surface can be coated with a photocatalyst, such as titanium dioxide, zinc oxide, and/or the like. Additionally, ultraviolet stabilizers or blockers can be used to absorb or reflect UV rays, thereby protecting surfaces from UV-induced degradation like color fading or material weakening. Selection of an appropriate coating depends on factors like application specifics and environmental conditions. For example, an interior pool surface may be treated with sealants to protect against stains and water penetration. Embodiments can use UV-resistant sealants and/or photocatalytic sealants for such surfaces. UV-resistant sealants are formulated to withstand UV exposure and maintain their protective properties. Illustrative UV-resistant coatings comprise acrylic resins, polyurethane, epoxy-based formulations with UV absorbers such as benzotriazole derivatives or hindered amine light stabilizers (HALS), and/or the like. Illustrative UV-resistant sealants include ceramic-based coatings, nano-oxides (e.g., alumina, silica, etc.), silicone-based sealants, and/or the like.

In embodiments, a far-UV light source 52 can be located in a recess of a corresponding fixture, which can be filled with a transparent material to protect the corresponding far-UV light source 52 from water and other contamination. Illustrative transparent materials include fused quartz, UVC silicones, clear acrylic, and/or the like. In embodiments, an external surface of the transparent material can include surface roughening and/or the like, which can cause, for example, the far-UV light to be scattered in different directions after passing through the surface.

Embodiments provide for the flexible placement of far-UV light sources 52 in any combination of various locations of the pool, which can enable highly customizable implementations and/or uniform disinfection of the pool 10. Embodiments can include additional fixtures for the far-UV light sources 52 located in any of various locations in the pool 10 beneath the water line. For example, one or more far-UV light sources 52 can be placed along the pool edges, on the bottom surface, and/or the like. As illustrated, far-UV light sources 52 can be mounted in locations more prone to experience microorganism growth, such as near corners of the pool 10, near a partially submerged ladder 32, near vertical surfaces, such as those of steps 14, a bench 16, near the drain 40 in the deep end 12B, on a bottom surface of a removable indicator 30 (e.g., a buoy), and/or the like. However, it is understood that these locations are only illustrative of various locations at which far-UV light sources 52 can be placed.

In embodiments, far-UV light sources 52 can be located in/mounted to one or more accessories associated with the pool 10. For example, a far-UV light source 52 can be mounted on a chlorine floater, which dispenses chlorine while floating in the pool 10. Additionally, a far-UV light source 52 can be mounted to/located in a bottom side of a pool brush, a pool vacuum head, and/or the like. Still further, a far-UV light source 52 can be mounted to/located on a bottom side of an automated pool cleaner, such as a robotic pool cleaner, and/or the like. In each case, embodiments of the far-UV light source 52 can turn on when the corresponding accessory is in the water and off after a predetermined period of time, when the accessory is removed from the water, and/or the like.

Additionally, one or more far-UV light sources 52 can be placed on an active feature, such as a removable indicator (e.g., lane dividing rope) 30, a ladder 32, and/or the like. Embodiments can include one or more far-UV light sources 52 located in conjunction with a fixture submerged in the pool water, such as a visible light fixture 34, a drain cover, a large particulate filter 48, a return jet 46, and/or the like. This adaptability can enable implementations of the treatment system that provide comprehensive coverage for treating all pool areas, including high-traffic zones and specific regions.

In each case, embodiments of a far-UV light source 52 can obtain power for operating the far-UV light source 52 using any solution. For example, a far-UV light source 52 can include a battery or other power supply. Additionally, a far-UV light source 52 can be physically wired to an external power supply, e.g., when incorporated with a visible light fixture 34 or its own fixture, such as when installed when the pool 10 is built or during a significant renovation of the pool 10. In embodiments, when implemented near a drain 40, a skimmer 42, a return jet 46, on a pool vacuum head, and/or the like, a far-UV light source 52 can be configured to obtain power for its operation from the movement of water past the far-UV light source 52.

In embodiments, a far-UV light source 52 can be configured to operate autonomously. For example, a far-UV light source 52 can be configured to be always on or implement a predetermined on/off cycle. For a far-UV light source 52 implemented next to flowing water, the far-UV light source 52 can be configured to operate while the water is flowing, e.g., operate always when the water is flowing, for a predetermined time after the water starts flowing, for on/off cycles of predetermined durations while the water is flowing, and/or the like. Similarly, when implemented in conjunction with a visible light source, a far-UV light source 52 can be configured to operate when the visible light source is on, when the visible light source is off, for a predetermined time after the light source is turned on or off, for on/off cycles of predetermined durations while the light source is turned on or off, and/or the like.

Embodiments of the far-UV light source 52 can include one or more ultraviolet light emitting diodes, one or more mercury-based lamps, one or more fluorescent lamps, and/or the like. In embodiments, a fixture for a component relating to the pool 10 can include light guiding structures, such as optical fibers and/or the like, which can direct light emitted from a far-UV light source 52 to one or more locations located on an external surface of the fixture from which the ultraviolet light is emitted.

In embodiments, a far-UV light source 52 can include a sensor, such as a water sensor switch that initiates or enables operation when contact with water is detected and halts or disables operation when no contact with water is detected.

Embodiments of the treatment system can include a treatment controller 54, which can control operation of some or all of the far-UV light sources 52, the external disinfection component 56, and/or the like. To this extent, the treatment controller 54 can receive data regarding the pool water, a surface of the pool, a surface of a pool feature, and/or the like, from one or more sensors, and operate the external disinfection component 56 and/or the far-UV light sources 52 based on the data received from the sensor(s). In embodiments, the treatment controller 54 can further obtain sensor data from and/or operate one or more components of the circulation and filtration system, such as the pump 41, the small particulate filter 49, and/or the like.

Embodiments of the treatment system can comprise one or more of any combination of various types of sensors that acquire the data used by the treatment controller 54. One or more of any type of sensor can be placed in any suitable locations in the pool 10 and/or components thereof. Such sensors can include real-time water quality detectors that continuously monitor water quality parameters such as pH, alkalinity, turbidity, microbial contamination, temperature, salt content, chlorine level (e.g., free chlorine and/or total chlorine), bromine level, cyanuric acid, hardness, and/or the like. A sensor can be located using its own fixture or be integrated into or attached to an existing feature of the pool 10 or a component thereof.

Such sensor data can be processed by the treatment controller 54 to dynamically adjust operation of the pump 41, the small particulate filter 49, the external disinfection component 56 (e.g., chemical treatment, UVC illumination), the far-UV light sources 52, and/or the like, based on the real time sensor data. In embodiments, the treatment controller 54 can communicate status information of one or more components and/or of the pool 10 for use by an external user. Such status information can include an error condition, a need for cleaning/replacement of a component, current water quality information for the water, treatment history, projection information for required supplies, etc.

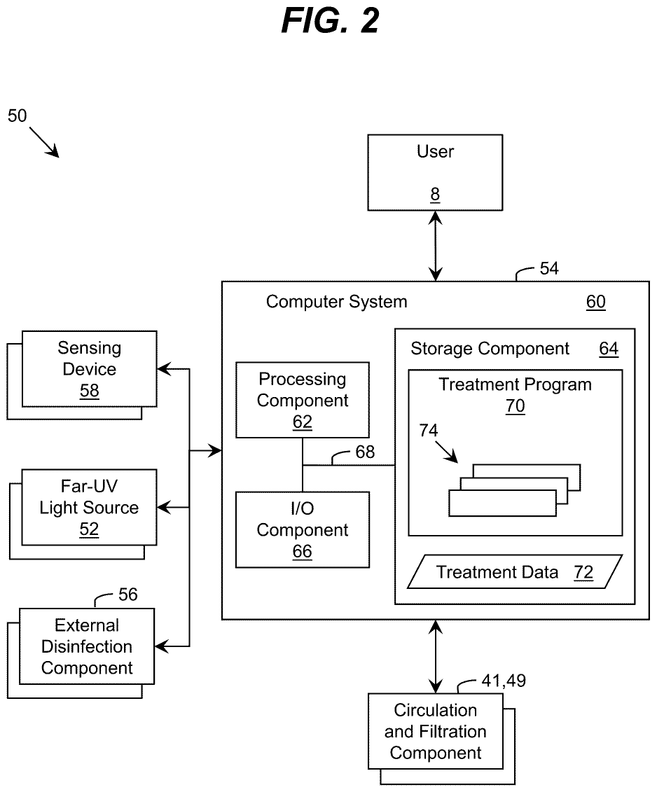

FIG. 2 shows a schematic of an illustrative treatment system 50 according to embodiments. To this extent, the treatment system 50 includes a treatment controller 54, which is implemented as a computer system 60 that can perform a process described herein in order to treat pool water, including with far-UV light. In particular, the computer system 60 is shown including a treatment program 70, which makes the computer system 60 operable to treat a volume of water and/or a surface corresponding to a pool area by performing a process described herein.

To this extent, the computer system 60 can receive sensor data regarding one or more water quality parameters for the water, an indication of contamination on a surface, a current status of use of the pool by one or more individuals, a current operating status of one or more components of the pool circulation and filtration system, and/or the like, from one or more sensing devices 58. The computer system 60 can process the sensor data and operate far-UV light source(s) 52, external disinfection component(s) 56, circulation and filtration component(s), such as the pump 41, the small particulate filter 49, valves associated therewith, and/or the like, based on the sensor data. Additionally, the computer system 60 can receive and perform operating instructions provided by the user 8 and/or communicate information regarding an operating status of one or more components of the treatment system 10 for presentation to the user 8.

The computer system 60 is schematically illustrated as including a processing component 62 (e.g., one or more processors), a storage component 64 (e.g., a storage hierarchy), an input/output (I/O) component 66 (e.g., one or more I/O interfaces and/or devices), and a communications pathway 68. In general, the processing component 62 executes program code, such as the treatment program 70, which is at least partially fixed in storage component 64. While executing program code, the processing component 62 can process data, which can result in reading and/or writing transformed data from/to the storage component 64 and/or the I/O component 66 for further processing. The pathway 68 provides a communications link between each of the components in the computer system 60.

The I/O component 66 can comprise one or more human I/O devices, which enable a human user 8 to interact with the computer system 60 and/or one or more communications devices to enable a system user 8 (e.g., a portable computing device of a human user, such as a mobile phone executing an app) to communicate with the computer system 60 using any type of communications link. To this extent, the treatment program 70 can manage a set of interfaces (e.g., graphical user interface(s), application program interface, and/or the like) that enable human and/or system users 8 to interact with the treatment program 70 and the treatment data 72, etc. Furthermore, the treatment program 70 can manage (e.g., store, retrieve, create, manipulate, organize, present, etc.) the treatment data 72 using any solution.

In any event, the computer system 60 can comprise one or more general purpose computing articles of manufacture (e.g., computing devices) capable of executing program code, such as the treatment program 70, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the treatment program 60 can be embodied as any combination of system software and/or application software.

Furthermore, the treatment program 70 can be implemented using a set of modules 74. In this case, a module 74 can enable the computer system 60 to perform a set of tasks used by the treatment program 70, and can be separately developed and/or implemented apart from other portions of the treatment program 70. As used herein, the term “component” means any configuration of hardware, with or without software, which implements the functionality described in conjunction therewith using any solution, while the term “module” means program code that enables a computer system 60 to implement the actions described in conjunction therewith using any solution. Regardless, it is understood that two or more components, modules, and/or systems may share some/all of their respective hardware and/or software. Furthermore, it is understood that some of the functionality discussed herein may not be implemented or additional functionality may be included as part of the computer system 60.

When the computer system 60 comprises multiple computing devices, each computing device can have only a portion of the treatment program 70 fixed thereon (e.g., one or more modules 74). In embodiments, the computer system 60 can comprise a computing unit which can be installed near the pool 10 (FIG. 1) and a portable computing unit, such as a mobile phone, which is executing an app installed thereon for enabling a user 8 to monitor, evaluate, manage, and/or the like, the illumination system. In embodiments, multiple computing units can be installed near the pool 10, each of which can operate independently or cooperatively with another computing unit to perform one or more treatment actions described herein. For example, a computing unit can be configured to operate the far-UV sources 52, while another computing unit is configured to independently operate the pump 41.

However, it is understood that the computer system 60 and the treatment program 70 are only representative of various possible equivalent computer systems that may perform a process described herein. To this extent, in other embodiments, the functionality provided by the computer system 60 and the treatment program 70 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 60 includes multiple computing devices, the computing devices can communicate over any type of communications link. Furthermore, while performing a process described herein, the computer system 60 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

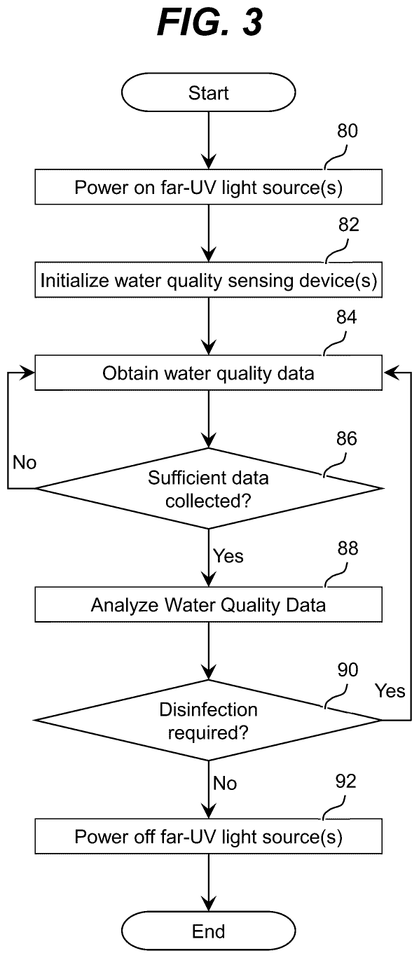

FIG. 3 shows an illustrative flow chart of a treatment process that can be implemented by the treatment controller 54 according to embodiments. Referring to FIGS. 2 and 3, at action 80, the treatment controller 54 can initially turn on one or more far-UV light sources 52. To this extent, as illumination with far-UV light is generally safe at any time and is effective at treating the pool water, the treatment controller 54 can use a default operating condition in which the far-UV light sources 52 are on.

In action 82, the treatment controller 54 can initialize the various water quality sensing devices 58. As part of the initialization, the treatment controller 54 can, for example, provide power to a sensing device 58 and allow the sensing device 58 to stabilize its operation. Additionally, the treatment controller 54 can ensure that the circulation and filtration component, such as the pump 41, are operating as many sensing devices 58 will return more accurate readings when the water is being circulated, with or without filtration.

In action 84, the treatment controller 54 can obtain water quality data from one or more of the water quality sensing device(s) 58. In action 86, the treatment controller 54 can determine whether sufficient water quality data has been collected, e.g., sufficient readings over a period of time, readings from a sufficient number of and/or types of sensing devices 58, etc.

When sufficient data has been obtained, in action 88, the treatment controller 54 can analyze the water quality data to determine various attributes of the water. In action 90, the treatment controller 54 can determine whether further disinfection of the water is required. If so, then the treatment controller 54 can return to action 84 and continue to obtain and evaluate the water quality data. Otherwise, in action 92, the treatment controller 54 can turn off the far-UV light source(s) 52 and exit the process. The treatment controller 54 can be configured to repeat the process in response to an event (e.g., power on, a request from a user 8), after a predetermined period of time, after or during a period of extensive use of the pool, and/or the like.

It is understood that the process shown in FIG. 3 is only illustrative. Embodiments of the treatment controller 54 can implement processes with any of various alternative actions. In embodiments, the treatment controller 54 can generate an error condition in response to the disinfection continuing to be required in action 90 for a period of time exceeding a maximum treatment period. In this case, such a situation may be indicative of extensive contamination of the water, malfunctioning sensors and/or light sources, ineffective configuration of the treatment system, and/or the like, any of which should be evaluated by a user 8 for possible actions.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

As also used herein, a layer is a transparent layer when the layer allows at least ten percent of radiation having a target wavelength, which is radiated at a normal incidence to an interface of the layer, to pass there through. Furthermore, as used herein, a layer is a reflective layer when the layer reflects at least ten percent of radiation having a target wavelength, which is radiated at a normal incidence to an interface of the layer. In an embodiment, the target wavelength of the radiation corresponds to a wavelength of radiation emitted or sensed (e.g., peak wavelength +/− five nanometers) by an active region of an optoelectronic device during operation of the device. For a given layer, the wavelength can be measured in a material of consideration and can depend on a refractive index of the material. Additionally, as used herein, a contact is considered “ohmic” when the contact exhibits close to linear current-voltage behavior over a relevant range of currents/voltages to enable use of a linear dependence to approximate the current-voltage relation through the contact region within the relevant range of currents/voltages to a desired accuracy (e.g., +/− one percent).

It is understood that, unless otherwise specified, each value is approximate and each range of values included herein is inclusive of the end values defining the range. Terms of degree such as “generally,” “substantially,” “about,” and “approximately” as used herein mean a reasonable amount of deviation of the modified term such that the end result is not significantly changed. For example, these terms can be construed as including a deviation of at least +/−0.5% of the modified term if this deviation would not negate the meaning of the word it modifies. In a more particular example, the term “approximately” is inclusive of values within +/− ten percent of the stated value, while the term “substantially” is inclusive of values within +/− five percent of the stated value when these deviations would not negate the meaning of the word each term modifies. Unless otherwise stated, two values are “similar” when the amount of deviation between the two values does not significantly change the result. In a more particular example, two values are similar when the smaller value is within +/− twenty-five percent of the larger value. A value, y, is on the order of a stated value, x, when the value y satisfies the formula 0.1x≤y≤10x.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A treatment system for a pool, the treatment system comprising:
at least one far-UV light source configured to emit far-UV light into water within the pool and/or onto a surface within the pool that is in contact or may contact the water; and
a treatment controller configured to manage treatment of the water and/or the surface by controlling operation of the at least one far-UV light source.

2. The treatment system of claim 1, wherein the at least one far-UV light source includes at least one far-UV light source located on an active feature of the pool.

3. The treatment system of claim 1, wherein the at least one far-UV light source includes at least one far-UV light source located in a fixture filled with a far-UV light transparent material.

4. The treatment system of claim 1, wherein the at least one far-UV light source includes at least one far-UV light source located on an accessory associated with the pool.

5. The treatment system of claim 1, further comprising at least one sensor configured to acquire data regarding the water and/or the surface, wherein the treatment controller is configured to manage operation of the at least one far-UV light source using the data.

6. The treatment system of claim 5, wherein the data includes data corresponding to a microbial contamination of the water.

7. A pool comprising:
a treatment system including:
at least one far-UV light source configured to emit far-UV light into water within the pool and/or onto a surface within the pool that is in contact or may contact the water; and
a treatment controller configured to manage treatment of the water and/or the surface by controlling operation of the at least one far-UV light source.

8. The pool of claim 7, wherein the at least one far-UV light source includes at least one far-UV light source configured to emit far-UV light onto a surface of a fixed passive feature of the pool.

9. The pool of claim 8, wherein the surface is a vertically oriented surface.

10. The pool of claim 7, wherein the at least one far-UV light source includes at least one far-UV light source configured to emit far-UV light onto a surface of an active feature of the pool.

11. The pool of claim 7, wherein the at least one far-UV light source includes at least one far-UV light source located on an active feature of the pool.

12. The pool of claim 7, wherein the at least one far-UV light source includes at least one far-UV light source configured to emit far-UV light onto a surface treated to prevent damage from the far-UV light or treated with a material used in conjunction with the far-UV light.

13. The pool of claim 7, wherein the at least one far-UV light source includes at least one far-UV light source located in a fixture filled with a far-UV light transparent material.

14. The pool of claim 7, wherein the at least one far-UV light source includes at least one far-UV light source located on an accessory associated with the pool.

15. The pool of claim 7, wherein the treatment controller is configured to operate the at least one far-UV light source to be on when water is flowing in the pool.

16. The pool of claim 7, further comprising at least one sensor configured to acquire data regarding the water and/or the surface, wherein the treatment controller is configured to manage operation of the at least one far-UV light source using the data.

17. The pool of claim 16, wherein the data includes data corresponding to a microbial contamination of the water.

18. The pool of claim 7, further comprising a circulation and filtration system, wherein the treatment controller is further configured to manage operation of the circulation and filtration system.

19. A pool comprising:
a circulation and filtration system; and
a treatment system including:
at least one far-UV light source configured to emit far-UV light into water within the pool and/or onto a surface within the pool that is in contact or may contact the water;
a treatment controller configured to manage treatment of the water and/or the surface by controlling operation of the at least one far-UV light source; and
at least one sensor configured to acquire data regarding the water and/or the surface, wherein the treatment controller is configured to manage operation of the at least one far-UV light source using the data.

20. The pool of claim 19, wherein the at least one far-UV light source includes at least one far-UV light source located on an active feature of the pool or an accessory of the pool.
